(19) United States
(12) Patent Application Publication
(10) Pub. No.: US 2025/0006482 A1
(43) Pub. Date: Jan. 2, 2025

(54) NANO-LITER PHOTOIONIZATION MASS SPECTROMETRY ION SOURCE DEVICE AND OPERATION METHOD THEREOF

(71) Applicant: National Institute of Metrology, China, Beijing (CN)

(72) Inventors: Xiaoyun GONG, Beijing (CN); Siyuan Tan, Beijing (CN); Xinhua Dai, Beijing (CN); Xiang Fang, Beijing (CN); You Jiang, Beijing (CN); Xinchi Yin, Beijing (CN); Rui Zhai, Beijing (CN); Tao Peng, Beijing (CN); Chang Li, Beijing (CN); Kangming Li, Beijing (CN); Xiaomei Gao, Beijing (CN)

(73) Assignee: National Institute of Metrology, China, Beijing (CN)

(21) Appl. No.: 18/343,405

(22) Filed: Jun. 28, 2023

(51) Int. Cl. H01J 49/16; H01J 49/00; H01J 49/04

(52) U.S. Cl. CPC H01J 49/161; H01J 49/0031; H01J 49/0445

(57) ABSTRACT

The present application relates to a nano-liter photoionization mass spectrometry ion source device and an operation method thereof. The nano-liter photoionization mass spectrometry ion source device includes a nano-tip, configured to load a sample solution, thus achieving a nano-electrospray process; a metal electrode, inserted into the nano-tip to contact with the sample solution directly, thus providing a high-voltage electric field for the nano-electrospray; and a UV lamp, configured to emit a high-energy ultraviolet photon to be combined with a gaseous molecule obtained by vaporizing the sample solution, thus achieving a photoionization process. Directed to the problems such as low ionization efficiency, poor sensitivity and more impurity interference existing in the unicellular mass spectrometry process of trace low-polar compounds in small-volume samples, a nano-liter photoionization mass spectrometry ion source device suitable for the analysis on low-polar compounds in small volume, e.g., polycyclic aromatic hydrocarbons (PAHs) is designed in the present application.

### TECHNICAL FIELD

The present application relates to the field of a nano-liter photoionization mass spectrometry ion source device, and in particular, to a nano-liter photoionization mass spectrometry ion source device and an operation method thereof.

### BACKGROUND

Mass spectrometry (MS) is an analytical technique for biochemical samples and features high throughput, high sensitivity and stronger ability to identify compounds. To meet the urgent need for accurate measurement of small-volume biological samples, a mass spectrometer has been mainly oriented to miniaturization and integration, thereby achieving the high-throughput analysis and accurate measurement on a trace amount of biological components in small volume samples.

Nano-electrospray ionization (nano-ESI) is a kind of high-sensitivity “soft ionization” ion source widely applicable to the analysis of polar compounds in small volume. Compared with conventional ESI, nano-ESI has a smaller nozzle bore and thus can achieve precise sampling of small-volume and unicellular samples, which has higher ionization efficiency and lower sample consumption. In nano-ESI, a small volume of sample solution is injected into a nano-tip and a high voltage (1-2 kV) is applied to the sample solution via electrodes. The sample solution is sprayed out from the end of the nano-tip under a high-voltage electric field, leading to the formation of nano-electrospray. Nano-tip is generally used for sampling in a small-volume analytical method based on nano-ESI. Nano-tip is controlled by a 3D mobile manipulator to conduct direct sampling from a target area of a biological sample in vivo under the real-time observation of a microscope. After sampling, MS analysis can be directly conducted through nano-ESI, or different compounds in the sample can be isolated in combination with capillary electrophoresis and other isolation techniques, and then detected. Even though the analytical method based on nano-ESI has been successfully applied to the ultra-sensitive analytical research on various kinds of small-volume and unicellular polar compounds, there still exists problems such as low detection sensitivity, poor ionization efficiency and complicated matrix interference to the analysis on the trace substances of small-volume and unicellular low-polar compounds.

Atmospheric pressure chemical ionization (APCI) and atmospheric pressure photoelectric ionization (APPI) are two ambient ion sources suitable for the analysis of low-polar compounds and non-polar compounds in large-volume samples. Directed to the problem that some of polar compounds and low-polar compounds are hard to be ionized, APCI generates reagent ions by means of corona discharge, and ionizes an analyte efficiently via gas-phase ionic/molecular reaction between the reagent ion and the analyte. Compared with APCI, APPI is generally applied to the analysis on low-polar compounds and non-polar compounds. APPI usually utilizes a low-wavelength ultraviolet light to motivate a gaseous analyte such that the analyte is ionized to free radical cations or further protonated into ions. Currently, APCI and APPI ways can be adopted to the large-volume analysis on low-polar compounds and non-polar compounds. However, it is difficult to implement effective MS ionization on a trace amount of low-polar substances in a small-volume unicellular sample.

Therefore, how to optimize the problems such as low ionization efficiency, poor sensitivity and more impurity interference existing in the unicellular MS process of trace low-polar compounds in small-volume samples has become an orientation to be studied at present.

### SUMMARY

To reduce the problems such as low ionization efficiency, poor sensitivity and matrix interference existing in the unicellular MS process of trace low-polar compounds in small-volume samples, the present application provides a nano-liter photoionization mass spectrometry ion source device and an operation method thereof.

In one aspect, the following technical solution is adopted in a nano-liter photoionization mass spectrometry ion source device provided herein.

A nano-liter photoionization mass spectrometry ion source device includes:
a nano-tip, configured to load a sample solution, thus achieving a nano-electrospray process;
a metal electrode, inserted into the nano-tip to contact with the sample solution directly, thus providing a high-voltage electric field for the nano-electrospray; and
a UV lamp, configured to emit a high-energy ultraviolet photon to be combined with a gaseous molecule obtained by vaporizing the sample solution, thus achieving a photoionization process.

By the above technical solution, when a high voltage is applied to the nano-tip, a sample to be analyzed in the nano-tip will be vaporized to form gaseous molecules, and then the gaseous molecules are combined with high-energy ultraviolet photons emitted by a UV lamp to achieve photoionization, thereby achieving the effective ionization and detection of target analytes.

Optionally, a square chamber is further included; an end portion of the nano-tip and the UV lamp are located inside the square chamber; the square chamber is filled with an inert shielding gas, to reduce the effect of the oxygen from the air on photoionization.

By adopting the above technical solution, the present disclosure may reduce the effect of the oxygen from the air on the transmission of the high-energy ultraviolet photons emitted by the UV lamp, to ensure the effective photoionization.

Optionally, the inert shielding gas may be nitrogen.

Optionally, a gas inlet and a gas outlet are formed on opposite sides of the square chamber for entry and exhaust of the inert shielding gas, respectively.

Optionally, a dopant inlet is formed on a side of the gas inlet on the square chamber.

Optionally, the nano-tip is made of a borosilicate glass.

Optionally, the metal electrode is made of an inert metal material.

Optionally, the inert metal material is a platinum wire.

In a second aspect, the present application provides an operation method of a nano-liter photoionization mass spectrometry ion source device, and the following technical solution is adopted.

An operation method of a nano-liter photoionization mass spectrometry ion source device is implemented by the nano-liter photoionization mass spectrometry ion source described above, including the following steps:
S1: sample introduction: injecting the sample solution from a tail end of the nano-tip such that a pointed end of the nano-tip is filled with the sample solution;
S2: linking: inserting one end of the metal electrode from the tail end of the nano-tip until an end portion of the metal electrode contacts with the sample solution, and sealing the tail end of the nano-tip with an insulated end cap, and linking one end located outside the nano-tip, of the metal electrode, to an external high voltage source; and
S3: detection: turning on the UV lamp and switching on the high voltage source to achieve the detection.

Optionally, during the detection of the step S3, nitrogen and a dopant are introduced into the square chamber prior to switching on the high voltage source.

In conclusion, the present application has at least the following beneficial technical effects.

1. The present disclosure achieves high-sensitivity detection on polycyclic aromatic hydrocarbons (PAHs) in a small-volume single cell and other samples to obtain higher signal intensity and signal-to-noise (S/N) result; compared with nano-ESI, the present disclosure achieves enhanced signal intensity (1-2 order of magnitudes).

2. The present disclosure has better selectivity, that is, has better detection response to low-polar compounds (in particular to aromatic compounds) in a mixed sample.

3. No dilution is required compared with a conventional APPI source with lower consumption of samples.

4. The present disclosure achieves the detection on the low-polar compound PAHs in a single cell; and

5. The structure is simple and it is easy to operate.

### BRIEF DESCRIPTION OF THE DRAWINGS

FIG. 1 is a schematic diagram showing an overall structure of an open nano-APPI according to the present application;

FIG. 2 is a schematic diagram showing an overall structure of a nitrogen-protective nano-APPI according to the present application;

FIG. 3A is a schematic diagram showing an MS result of the benzo[a]anthracene by nitrogen-protective nano-APPI;

FIG. 3B is a schematic diagram showing an MS result of the benzo[a]anthracene by open nano-APPI;

FIG. 3C is a schematic diagram showing an MS result of benzo[a]anthracene by conventional nano-ESI;

FIGS. 4A-F show test results of six PAHs at different concentrations by three mass spectrometry ion sources: FIG. 4A fluoranthene; FIG. 4B benzo[a]anthracene; FIG. 4C chrysene;

FIG. 4D benzo[k]fluoranthene; FIG. 4E indeno [1,2,3-cd]pyrene, and FIG. 4F dibenzo[a,h]anthracene;

FIGS. 5A-F show test results of the six PAHs by nitrogen-protective nano-APPI mass spectrometry: FIG. 5A indeno [1,2,3-cd]pyrene; FIG. 5B dibenzo[a,h]anthracene; FIG. 5C fluoranthene; FIG. 5D benzo[a]anthracene; FIG. 5E benzo[k]fluoranthene, and FIG. 5F chrysene;

FIGS. 6A-F show test results of the six PAHs by nano-ESI mass spectrometry: FIG. 6A indeno [1,2,3-cd]pyrene; FIG. 6B dibenzo[a,h]anthracene; FIG. 6C fluoranthene; FIG. 6D benzo[a]anthracene; FIG. 6E benzo[k]fluoranthene, and FIG. 6F chrysene;

FIGS. 7A-B are schematic diagrams showing test results of six mixed-standard samples under nano-ESI and nano-APPI mass spectrometry; and

FIGS. 8A-B are schematic diagrams showing test results of a K562 unicellular sample after being treated by benzo[a]anthracene under nano-ESI and nano-APPI mass spectrometry.

### DETAILED DESCRIPTION OF THE EMBODIMENTS

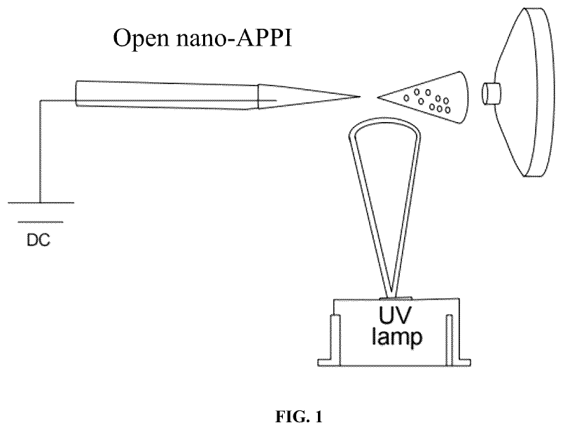

The present application will be further described in detail below with reference to FIGS. 1-8.

The present application discloses a nano-liter photoionization mass spectrometry ion source device for MS test. The MS test was completed on an Orbitrap Elite Mass Spectrometry (Thermo Scientific, San Jose, CA, USA). The device parameters were configured below: capillary temperature was 275° C. and spray voltage was +3.0 kV.

### Example 1

Referring to FIG. 1, the nano-liter photoionization mass spectrometry ion source device contains an open nano-liter photoionization mass spectrometry ion source device (nano-APPI). The photoionization of the open nano-APPI was implemented at atmospheric pressure. The open nano-APPI includes a nano-tip, a metal electrode and a UV lamp.

The nano-tip is configured to load a sample solution and provide a place of occurrence for the open nano-APPI; the nano-tip is made of a glass, and specifically a borosilicate glass, and has a pointed end bore of 2-5 μm. The sample solution is injected from a tail end of the nano-tip until the pointed end of the nano-tip is filled with the sample solution; of course, the sample solution may be also absorbed at the pointed end of the nano-tip by capillary action, and then a solution was added at the tail end to assist electric conduction.

The metal electrode is inserted into the nano-tip to contact with the sample solution directly, thus providing a high-voltage electric field for the occurrence of the open nano-APPI; the material of the metal electrode is not limited but should be chemically inert, that is, it is not easy to conduct chemical reaction with the sample solution, resulting in corrosion and dissolution. Generally, it is an inert metal material, specifically a platinum wire.

The UV lamp is configured to emit high-energy ultraviolet photons to be combined with gaseous molecules obtained by vaporizing the sample solution, thus achieving a photoionization process. Heraeus PSK106 UV exciter lamp was used and filled with a noble gas Kr, and had an excitation energy of 10.6 eV and an ultraviolet wavelength of 117 nm.

Example 1 was implemented by the following principle: a columnar UV lamp filled with a noble gas is placed between an MS inlet on an Orbitrap mass spectrometer and the pointed end of a nano-spray probe; the UV lamp is located 1 cm away from the MS inlet and lower portion of the pointed end of the nano-spray probe; the UV lamp is fixed with an external platform frame and other auxiliary equipment, thus ensuring that the distance between the UV lamp and the gaseous sample molecule sprayed by the pointed end of the nano-spray probe is kept constant. When a high voltage is applied to the nano-spray probe, a sample solution to be analyzed in the nano-spray probe may be vaporized to form gaseous molecules, and then the gaseous molecules are combined with high-energy ultraviolet photons emitted by the UV lamp at the bottom of the pointed end of the nano-spray probe to complete photoionization, thereby achieving MS detection of the substance to be analyzed finally.

### Example 2

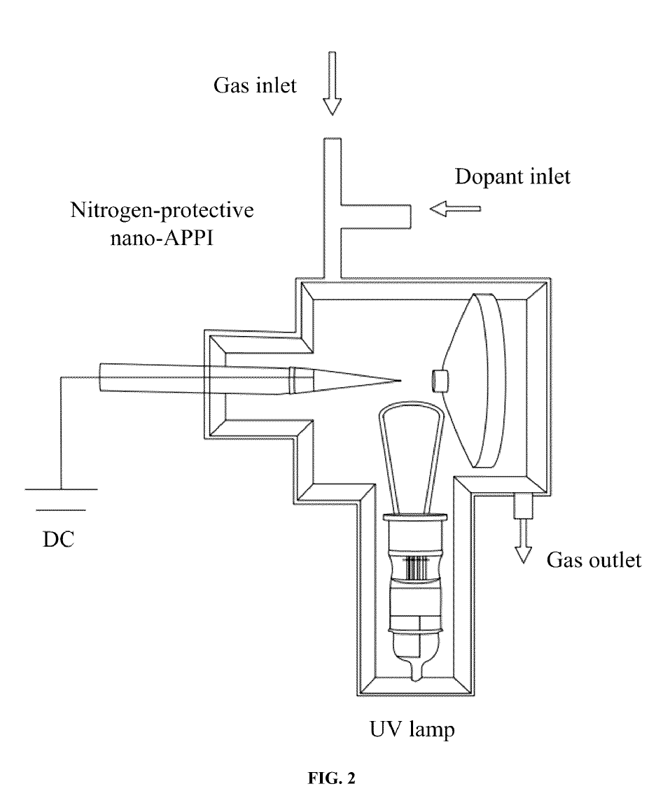

Referring to FIG. 2, the nano-liter photoionization mass spectrometry ion source device contains a nitrogen-protective nano-liter photoionization mass spectrometry ion source device (nano-APPI). The nitrogen-protective nano-APPI differs from the open nano-APPI in that the nitrogen-protective nano-APPI further includes a square chamber that is filled with an inert shielding gas to reduce an effect of oxygen from the air on the high-energy ultraviolet photon, where the nano-tip and the UV lamp are located in the square chamber. Meanwhile, a sample inlet is formed on the square chamber for allowing the nano-tip to be inserted, and has a diameter of 1 mm.

Specifically, the inert shielding gas may be selected from nitrogen; a gas inlet and a gas outlet are formed on opposite sides of the square chamber for entry and exhaust of nitrogen, respectively such that the whole square chamber maintains circulation of the inert gas. The gas outlet has a diameter of 0.5 mm. When nitrogen is continuously introduced into the square chamber, air in the square chamber will be exhausted effectively and the whole square chamber is filled with nitrogen, and concentration of the nitrogen in the square chamber may be kept effectively. A dopant inlet is further formed on the square chamber. The dopant inlet may be disposed at one side of the square chamber towards the gas inlet, and also may be directly communicated with a side wall of the gas inlet. The design of such a square chamber may prevent the high-energy ultraviolet photon emitted by the UV lamp from being affected by oxygen from the air during transmission, which preserves more photons to be combined with gaseous molecules obtained by vaporizing the sample solution, thus avoiding interference of oxygen in the art.

The square chamber may be made of a polymer polysulfone which has better thermal stability and may ensure a higher ionization temperature during photoionization.

Example 2 was implemented by the following principle: a pointed end of the nano-tip was inserted into the square chamber filled with nitrogen via the MS inlet; moreover, the distance between the pointed end of the nano-tip and the MS inlet on an Orbitrap mass spectrometer was kept around 5 mm. Nitrogen and the dopant were communicated into the square chamber, and then the UV lamp was mounted in the square chamber, and a constant distance of 5 mm was kept between the UV lamp and the pointed end of the nano-tip, and the UV lamp was connected to a high voltage module to be charged with electricity and emit light. Nitrogen may reduce the interference of oxygen in the art on the high-energy ultraviolet photon emitted by the UV lamp during transmission, which further improves the ionization efficiency of low-polar compounds.

The present application further discloses an operation method of a nano-liter photoionization mass spectrometry ion source device. The operation method includes the following steps:
S1: sample introduction: the sample solution was injected from a tail end of the nano-tip such that a pointed end of the nano-tip was filled with the sample solution;
S2: linking: one end of the metal electrode was inserted from the tail end of the nano-tip until an end portion of the metal electrode contacted with the sample solution, and the tail end of the nano-tip was sealed with an insulated end cap, and one end located outside the nano-tip, of the metal electrode, was connected to an external high voltage source; and
S3: detection: the UV lamp was turned on and switching on the high voltage source was switched on to achieve the detection.

The above steps are directed to the operation method for the open nano-APPI. For the nitrogen-protective nano-APPI, step S3 further includes introducing nitrogen and the dopant into the square chamber prior to switching on the external high voltage source, thus achieving detection. Nitrogen was introduced at a flow rate of 400 mL/min and the dopant was introduced at a flow rate of 100 mL/min.

The detection effect of the nano-liter photoionization mass spectrometry ion source device was validated by detailed examples below.

### (1) Comparison on the Detection Effects of Three Ion Sources

To prove the advantages of the designed open nano-APPI source and nitrogen-protective nano-APPI source in the detection of low-polar compounds better, the nitrogen-protective nano-APPI source, the open nano-APPI source and a conventional nano-ESI source were subjected to comparison validation on the MS detection sensitivity of 0.1 mmol/L benzo[a]anthracene.

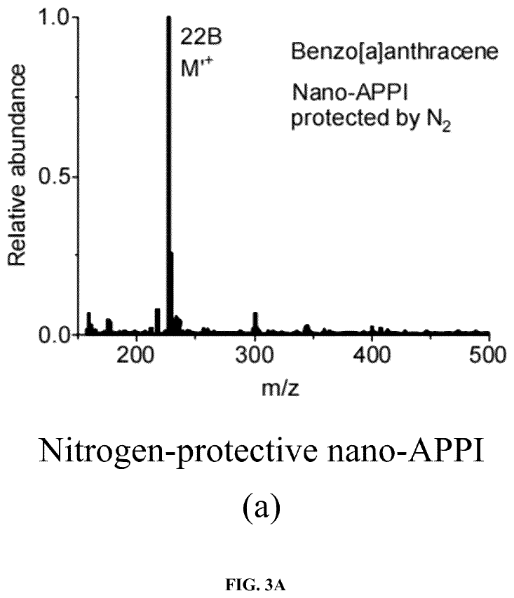

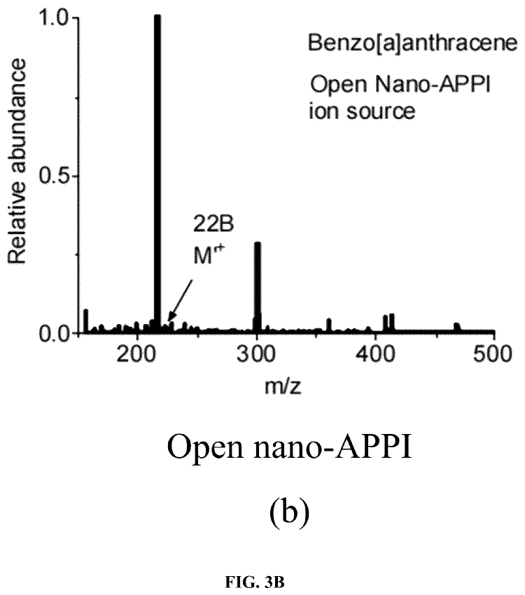

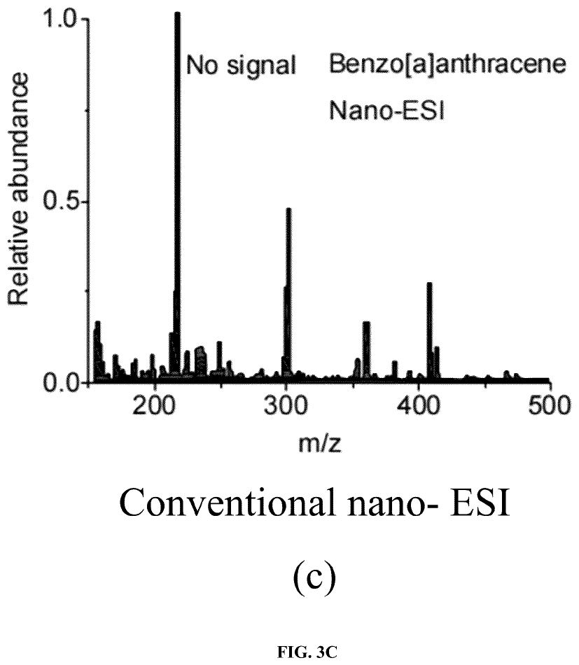

FIGS. 3A-C show comparison on MS results of the three designed ion sources to benzo[a]anthracene, where benzo[a]anthracene used in the test is an environmental toxicant standard with a molecular weight of 228. Benzo [a]anthracene was then dissolved into acetonitrile to obtain 0.1 mmol/L of a solution sample to be analyzed, directly used for detection. Data acquisition was conducted within a range of 150-500 m/z. The arrow denotes the signal of the substance to be analyzed.

As shown in FIG. 3A, the nitrogen-protective nano-APPI source shows optimal detection sensitivity to benzo[a]anthracene with a signal-to-noise (S/N), being up to 155. As shown in FIG. 3B, the open nano-APPI source shows significantly reduced detection sensitivity to benzo[a]anthracene with an S/N, being up to 42 only. As shown in FIG. 3C, the conventional nano-ESI source is hardly to detect benzo[a]anthracene and no characteristic signal may be observed, and the S/N result tends to be 0. The results prove that protected by nitrogen, the semi-closed nano-APPI source may eliminate the interference of oxygen molecules better, thus improving the binding rate of photon to the sample and greatly increasing the photoionization efficiency. The open nano-APPI source may be interfered by oxygen molecules, photon may be bound to oxygen molecules to reduce the ionization efficiency of the target molecule. For lack of UV lamp, the conventional nano-ESI ion source is hardly to ionize benzo[a]anthracene, such a low-polar compound without an ionized functional group.

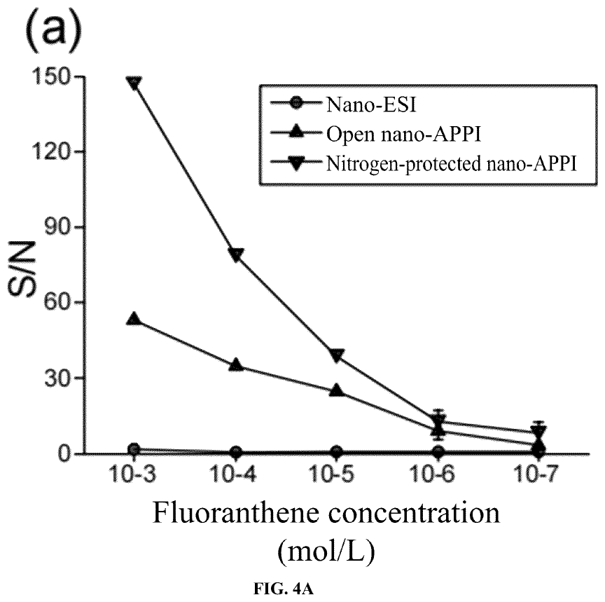

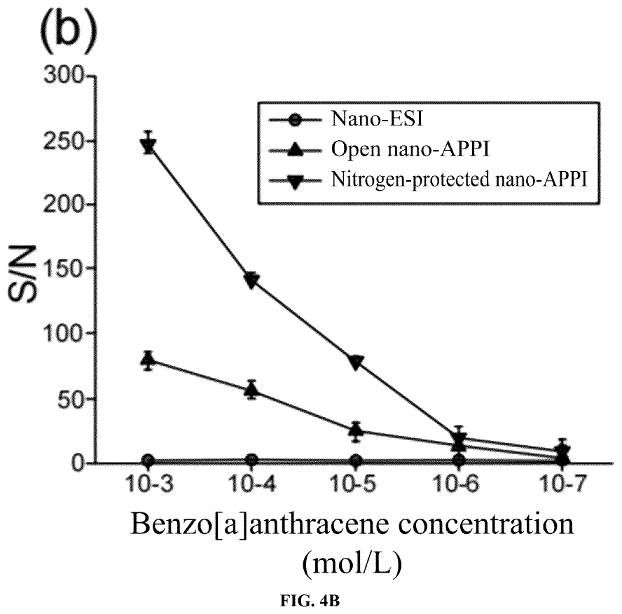

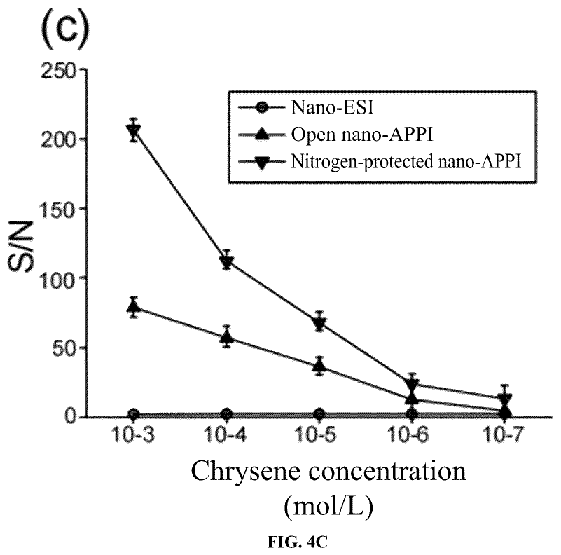

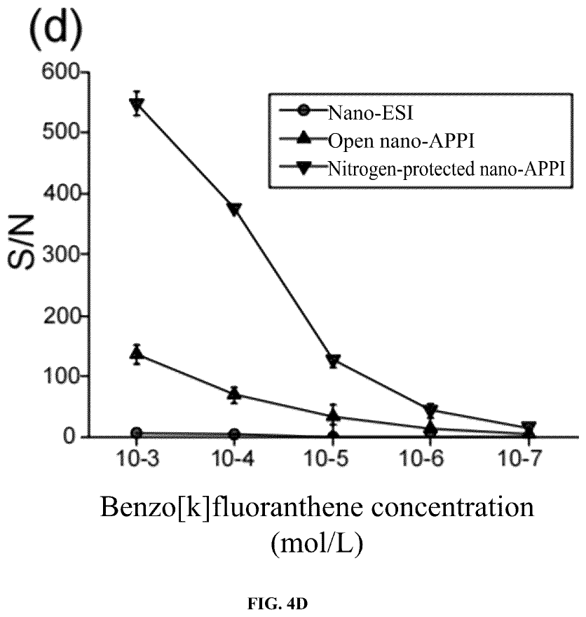

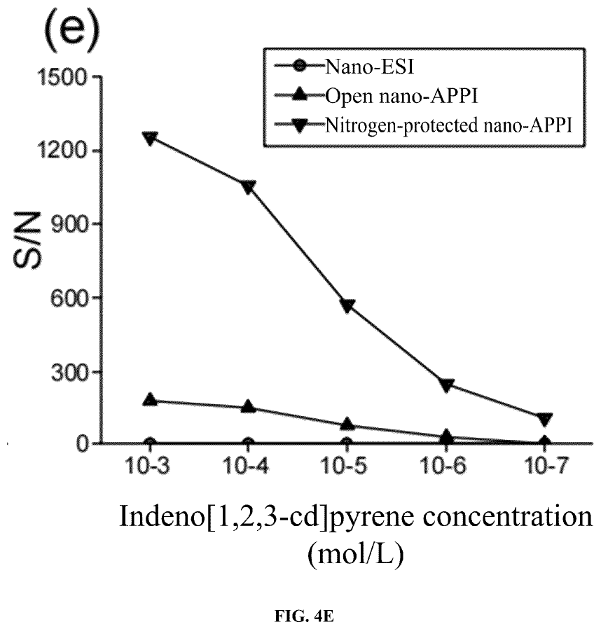

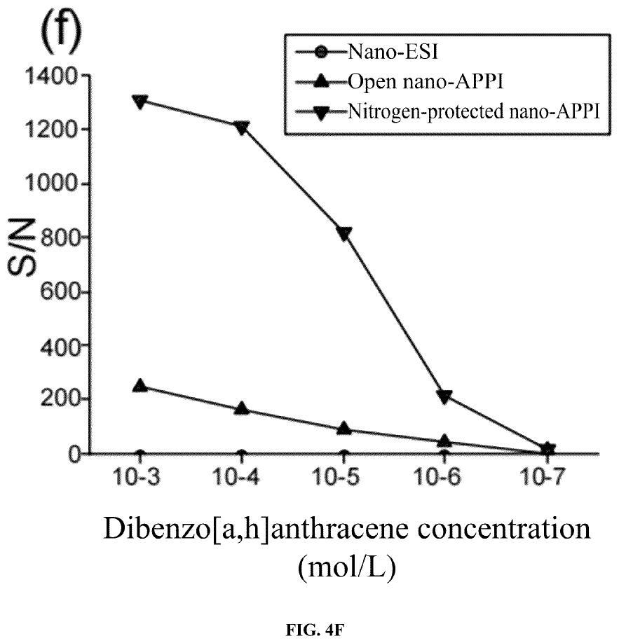

Tests at different concentrations of PAHs were further conducted, as shown in FIGS. 4A-F. Six PAHs were tested at five concentrations of 1.0-0.1 μmol/L, respectively to obtain the S/N results detected by the conventional nano-ESI, open nano-APPI and nitrogen-protective nano-APPI sources at different concentrations.

The S/N detected by the nano-ESI ion sources on the six PAHs was very low and tended to 0; moreover, when the concentration of the sample to be analyzed changed from 1.0 mmol/L to 0.1 μmol/L, the S/N detected by the nano-ESI ion source approximated a straight line; high concentration of 1.0 mmol/L PAHs sample still failed to obtain a relatively high nano-ESI ion source MS signal; three repeats were conducted for each of the PAHs per concentration, but the results still showed a same S/N trend detected by nano-ESI ion sources. Therefore, it is indicated that the nano-ESI ion source may not achieve effective ionization detection on PAHs, and it thus may be determined that the nano-ESI ion source may not achieve effective ionization on low-polar compounds, PAHs.

When the concentration of the PAHs sample changed from high to low, the signal detected corresponding to the open nano-APPI source tended from high to low as well, and was greater than the background S/N and S/N of the nano-ESI ion source at the same concentration. The average S/N detected was 1.0×10¹ order of magnitude, and the S/N detected of the PAHs sample having a higher mass number may be up to 1.0×10² order of magnitudes. Moreover, the S/N detected at 1.0 μmol/L was less than 3. Therefore, the open nano-APPI source had a limit of detection (LOD) of 1.0 μmol/L. Moreover, it was found that the S/N detected of the PAHs sample having a low mass number was greater than that of the PAHs sample having a high mass number.

Further, when the concentration of the PAHs sample decreased, the signal detected corresponding to the nitrogen-protective nano-APPI source tended from high to low as well, and was greater than the background S/N and the S/N detected of the nano-ESI ion source and open nano-APPI source at the same concentration. Moreover, at a concentration of 1.0 mmol/L, the PAHs sample having a low mass number (fluoranthene, benzo[a]anthracene, chrysene, and benzo[k]fluoranthene) may obtain an S/N with 1.0×10² order of magnitudes, and at the same concentration, the PAHs sample having a high mass number (indeno [1,2,3-cd]pyrene and dibenzo[a,h]anthracene) may obtain an S/N with 1.0×10³ order of magnitudes. At a lower concentration of 0.1 μmol/L, the S/N detected also may be up to 1.0×10¹ above. Therefore, it may be indicated that the nitrogen-protective nano-APPI source may achieve the effective ionization of low-polar compounds, and its LOD may be up to 0.1 μmol/L.

### (2) Detection of Various PAHs by the Nitrogen-Protective Nano-APPI Source

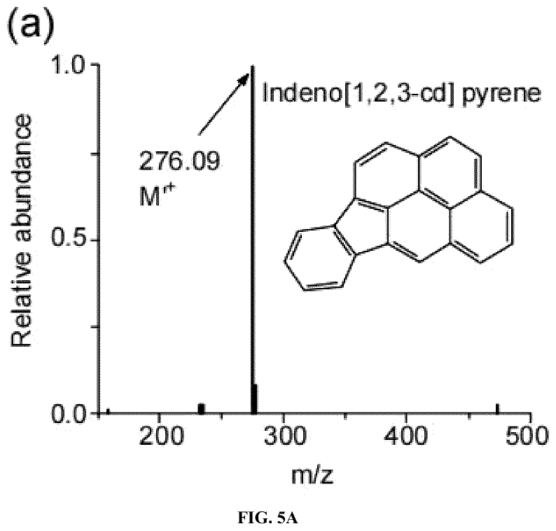

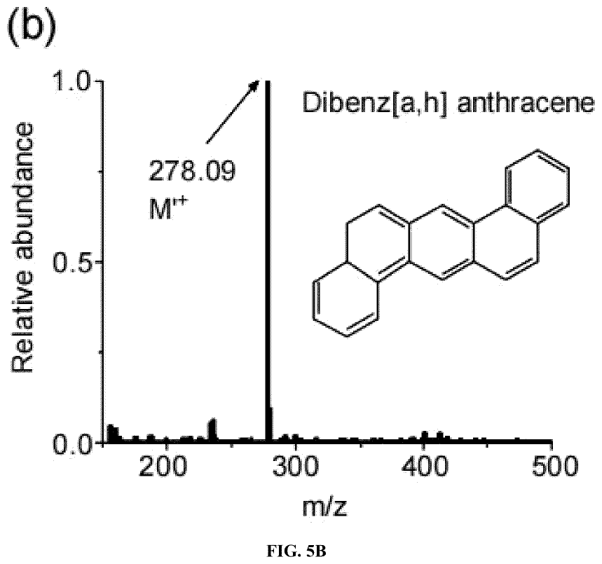

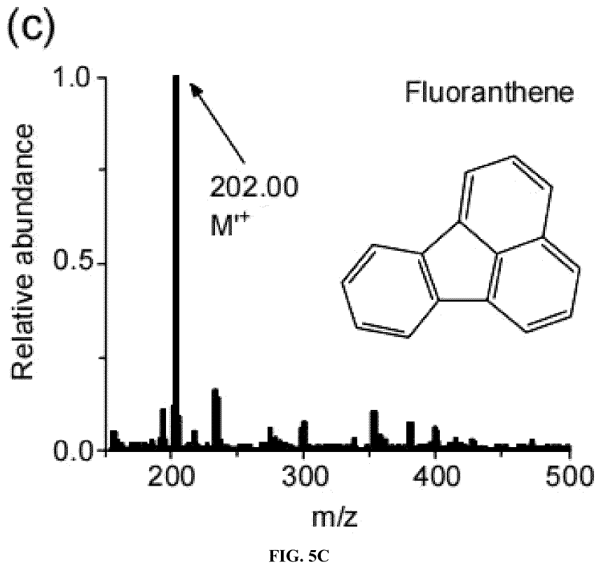

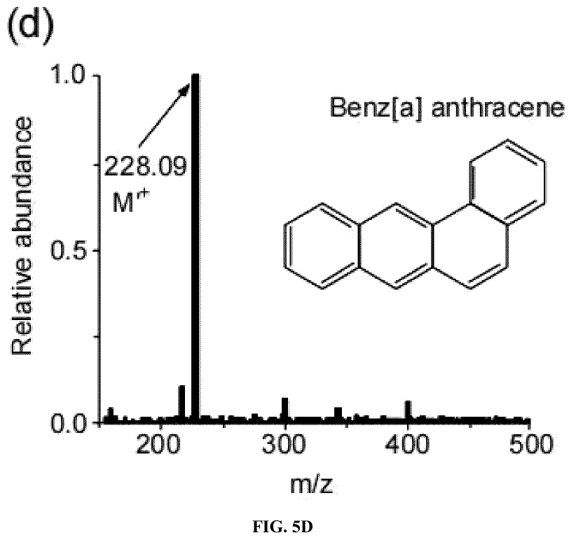

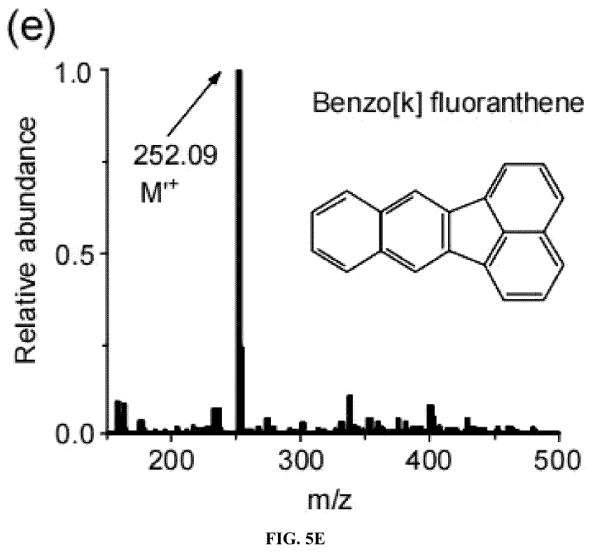

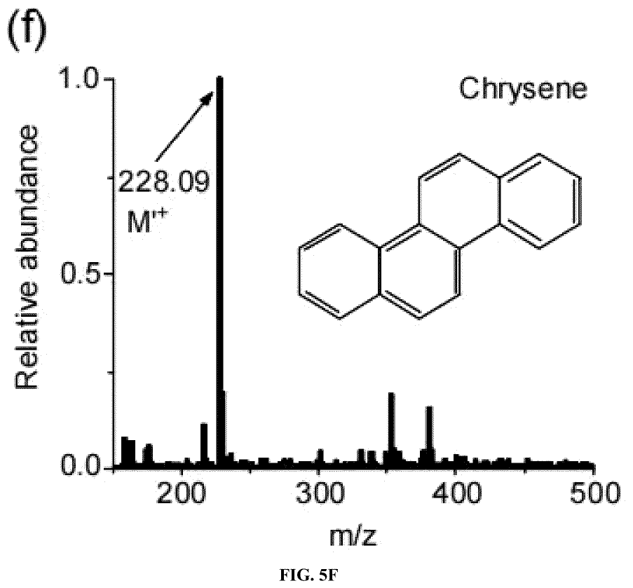

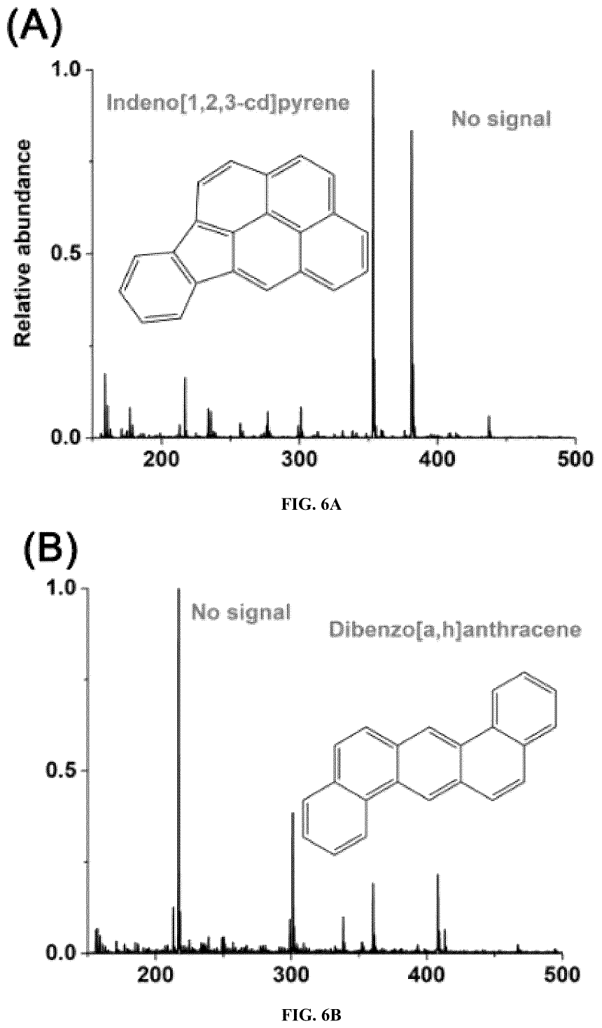

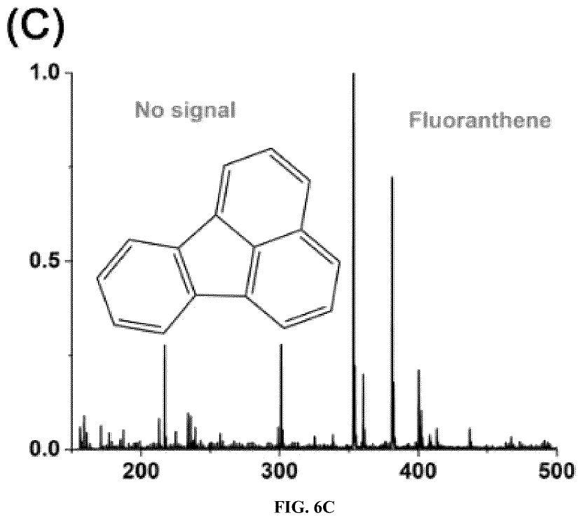

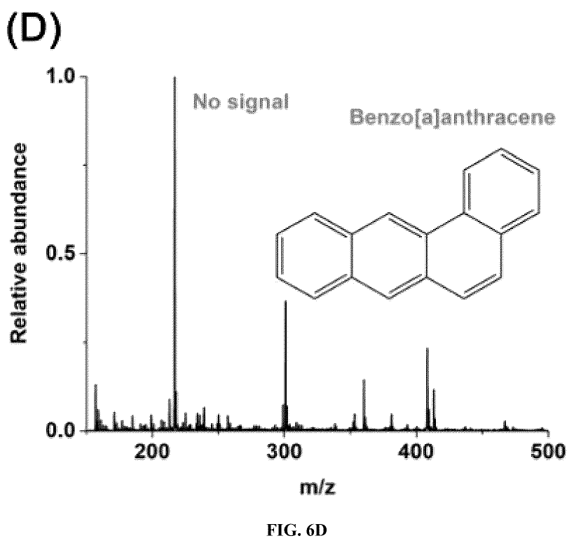

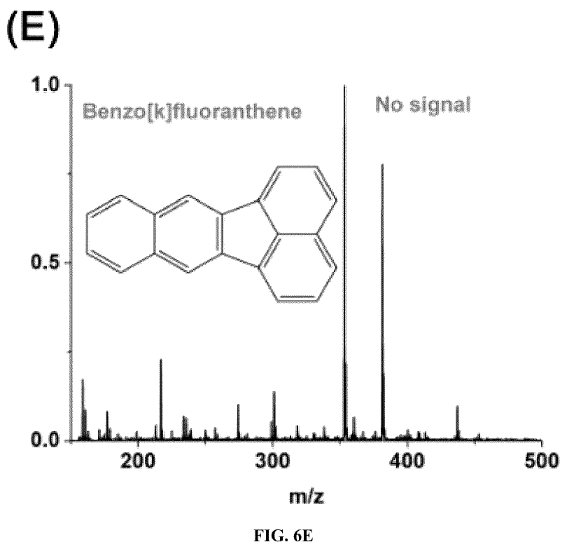

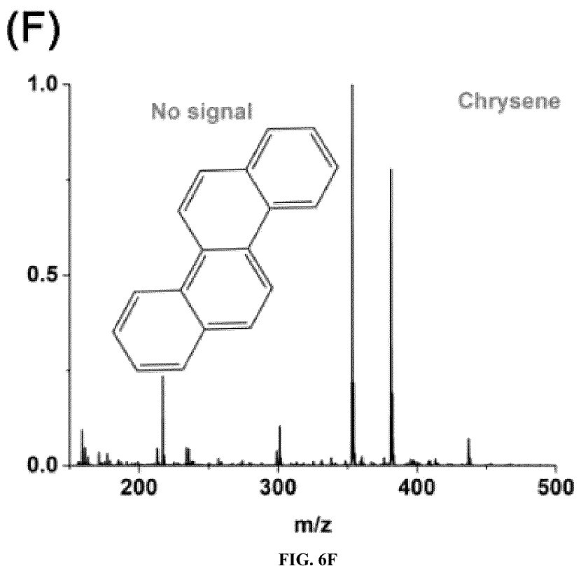

Six different types of PAHs with the same concentration (0.1 mmol/L) (fluoranthene, benzo[a]anthracene, chrysene, benzo[k]fluoranthene, dibenzo[a,h]anthracene, and indeno [1,2,3-cd]pyrene) were chosen and subjected to contrast tests of nitrogen-protective nano-APPI and nano-ESI. The results are shown in FIGS. 5-6.

FIGS. 5A-F show MS results of the six PAHs in hydrogen-protective nano-APPI and shows that the designed nitrogen-protective nano-APPI device has better ionization efficiency. The S/N detection results of the six PAHs were as follows: fluoranthene: 79.47; benzo[a]anthracene: 141.38; chrysene: 112.56; benzo[k]fluoranthene: 378.06; indeno [1,2,3-cd]pyrene: 1058.11; and dibenzo[a,h]anthracene: 1243.31.

FIGS. 6A-F show MS comparison results of the six PAHs in nano-ESI, and the results show poor detection sensitivity, and it fails to obtain a signal of the target compound accurately, and the S/N result tends to 0.

The results indicate that the designed nitrogen-protective nano-APPI source significantly improves the ionization efficiency to low-polar compounds PAHs, improves the detection efficiency of the low-polar compounds, and thus lays the foundation to the analysis on trace low-polar compounds in small-volume samples.

### (3) Detection of the Mixed-Standard Sample by the Nitrogen-Protective Nano-APPI Source

To further specify the detection effect of the designed nitrogen-protective nano-APPI platform on low-polar compounds in a complex material environment, three PAHs compounds and three conventional polar compounds were subjected to MS detection by the nitrogen-protective nano-APPI and nano-ESI. The mixed standard sample contains 0.1 mmol/L of chrysene, benzo[k]fluoranthene, dibenzo[a,h]anthracene, histidine, arginine, and saccharose. The mixed-standard sample was dissolved into a pure acetonitrile solvent.

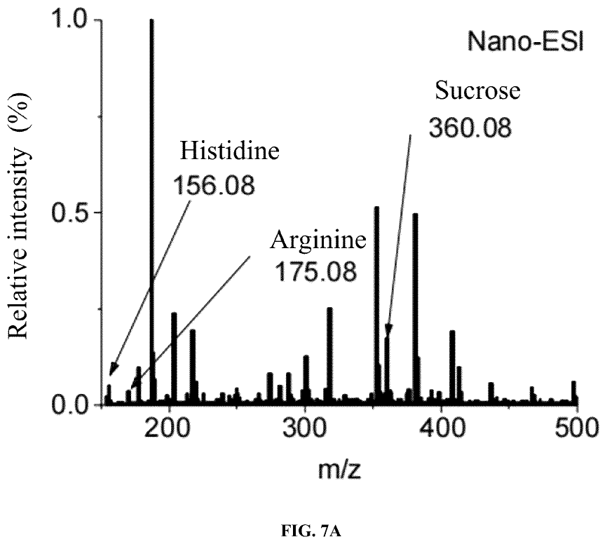

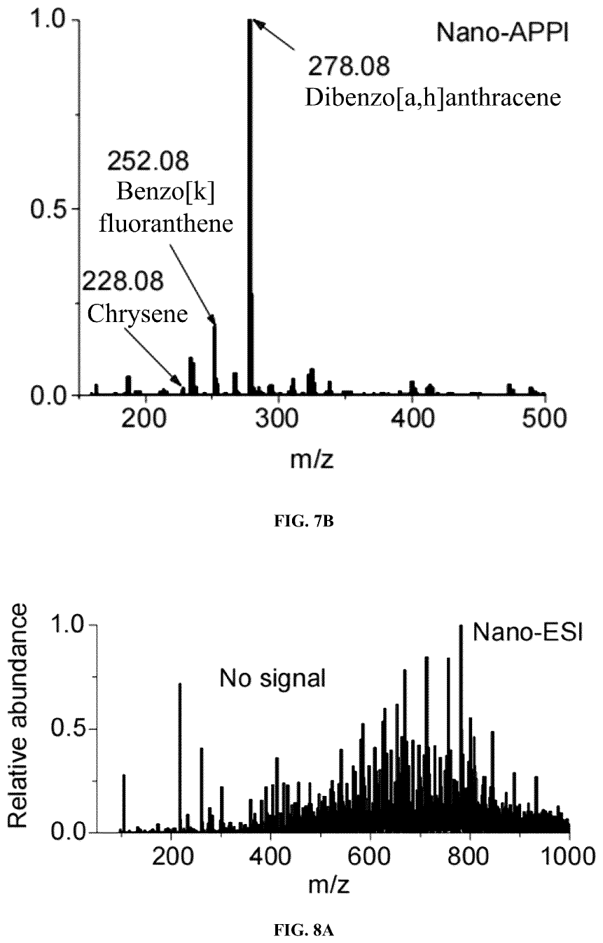

FIGS. 7A-B show MS results of the six mixed standard samples in the nano-ESI ion source and nitrogen-protective nano-APPI source. The six mixed samples to be analyzed were detected by a nano-ESI source; substances with stronger polarity of histidine, arginine, and sucrose may be detected better, but the corresponding MS signal peaks have lower relative signal intensity (SI). The three low-polar compounds PAHs, chrysene, benzo[k]fluoranthene, and dibenzo[a,h]anthracene are hard to be detected, and there is hardly no corresponding m/z present in the mass spectrum. It is indicated that the nano-ESI source platform is easier to achieve detection on polar compounds, but difficult to achieve the MS ionization detection on substances with lower polarity. By contrast, the nitrogen-protective nano-APPI source platform may achieve better detection on the three low-polar substances, chrysene, benzo[k]fluoranthene, and dibenzo[a,h]anthracene, thus obtaining MS signal peaks with a higher S/N, and there is lower background interference. However, the nitrogen-protective nano-APPI source platform has no high detection signal intensity to the three polar compounds, amino acids and saccharose; therefore, it is predicted that the nano-APPI has better selective ionization, and has a photoionization efficiency on the low-polar compound greater than the ionization efficiency on the polar compound. Accordingly, the ionized low-polar ion has a concentration greater than that of the polar ion, such that the low-concentration substance may not be detected. Moreover, as can be seen, the m/z MS signal peak corresponding to dibenzo[a,h]anthracene detected by the nitrogen-protective nano-APPI source platform has the highest relative SI, followed by the benzo[k]fluoranthene, and the m/z MS signal peak corresponding to chrysene has the lowest relative SI. The results prove that the nitrogen-protective nano-APPI source is more suitable for the ionization detection of high-molecular weight compounds. To sum up, the nano-ESI source platform is easier to achieve the ionization detection and analysis on polar substances, while the nitrogen-protective nano-APPI source platform is easier to achieve the efficient detection on low-polar compounds in a complicated sample environment.

### (4) Detection Result of a Unicellular Sample by the Nitrogen-Protective Nano-APPI Source

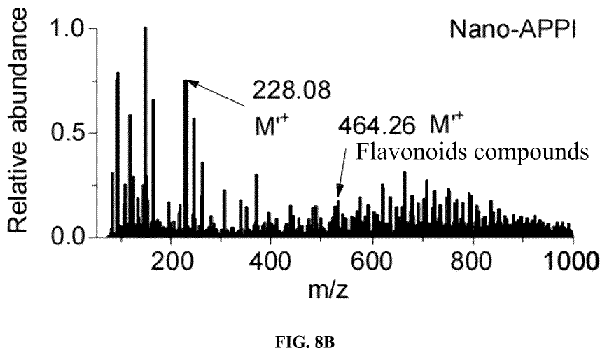

Lots of environmental contaminants will get into a biological cell and are bound to a specific receptor in the cell, and then transformed via a metabolic enzyme, thereby affecting growth and development of the cell finally. PAHs are a series of cell contaminants rather harmful to the human body. PAHs are transformed into an ionic form by binding to a specific receptor through metabolism and then bound to genetic material DNA or RNA in cells, leading to cytometaplasia and canceration. The detection of substances in a single cell not only includes the detection on the six categories of major compounds itself, but also some substances absorbed from the environment. To detect low-polar compounds PAHs in a single cell is of great significance in the subsequent disease prevention and diagnosis, environmental governance as well as controlling harmful ingredients in food and drug. The nitrogen-protective nano-APPI-MS would be continuously applied in the present application to detect the low-polar compounds PAHs in a K562 cell after being treated and cultured by benzo[a]anthracene (as shown in FIGS. 8A-B).

As can be seen from the above mass spectrum, the nitrogen-protective nano-APPI source may successfully detect benzo[a]anthracene in the K562 cell and may further detect other low-polar compounds, e.g., flavonoids compounds in the cell. Compared with the conventional nano-ESI, the conventional nano-ESI is difficult to effectively detect benzo[a]anthracene, while nano-APPI may detect low-polar compounds, e.g., PAHs in a single cell better, and shows a very good S/N result. Moreover, nano-APPI may also detect some low-polar compounds, e.g., flavonoids compounds, in endogenous single cells which are hard to be detected by nano-ESI.

As can be seen from the mass spectrum obtained in the K562 cell test, the nitrogen-protective nano-APPI may effectively achieve high-sensitivity detection on low-polar compounds in a single cell. Moreover, it has been found that the nano-APPI source developed herein may not only achieve the detection on exogenous low-polar compounds, but also may achieve monitoring and analysis on endogenous low-polar metabolites.

The above are preferred embodiments of the present application, but the protection scope of the present application is not limited thereto. Therefore, all equivalent changes made in accordance with the structure, shape, and principle of the present application shall fall within the protection scope of the present application.

We claim:

1. A nano-liter photoionization mass spectrometry ion source device, comprising:
a nano-tip, configured to load a sample solution, thus achieving a nano-electrospray process;
a metal electrode, inserted into the nano-tip to contact with the sample solution directly, thus providing a high-voltage electric field for the nano-electrospray; and
a UV lamp, configured to emit a high-energy ultraviolet photon to be combined with a gaseous molecule obtained by vaporizing the sample solution, thus achieving a photoionization process.

2. The nano-liter photoionization mass spectrometry ion source device according to claim 1, further comprising a square chamber, wherein an end portion of the nano-tip and the UV lamp are located inside the square chamber, and the square chamber is filled with an inert shielding gas to reduce an effect of oxygen from the air on photoionization.

3. The nano-liter photoionization mass spectrometry ion source device according to claim 2, wherein the inert shielding gas is nitrogen.

4. The nano-liter photoionization mass spectrometry ion source device according to claim 2, wherein a gas inlet and a gas outlet are formed on opposite sides of the square chamber for entry and exhaust of the inert shielding gas, respectively.

5. The nano-liter photoionization mass spectrometry ion source device according to claim 4, wherein a dopant inlet is formed on a side of the gas inlet on the square chamber.

6. The nano-liter photoionization mass spectrometry ion source device according to claim 1, wherein the nano-tip is made of a borosilicate glass.

7. The nano-liter photoionization mass spectrometry ion source device according to claim 1, wherein the metal electrode is an inert metal material.

8. The nano-liter photoionization mass spectrometry ion source device according to claim 7, wherein the inert metal material is a platinum wire.

9. An operation method of a nano-liter photoionization mass spectrometry ion source device, implemented by the nano-liter photoionization mass spectrometry ion source device according to claim 1, and comprising the following steps:
S1: sample introduction: injecting the sample solution from a tail end of the nano-tip such that a pointed end of the nano-tip is filled with the sample solution;
S2: linking: inserting one end of the metal electrode from the tail end of the nano-tip until an end portion of the metal electrode contacts with the sample solution, and sealing the tail end of the nano-tip with an insulated end cap, and linking one end located outside the nano-tip, of the metal electrode, to an external high voltage source; and
S3: detection: turning on the UV lamp and switching on the high voltage source to achieve the detection.

10. The operation method of a nano-liter photoionization mass spectrometry ion source device according to claim 9, further comprising a square chamber, wherein an end portion of the nano-tip and the UV lamp are located inside the square chamber, and the square chamber is filled with an inert shielding gas to reduce an effect of oxygen from the air on photoionization.

11. The operation method of a nano-liter photoionization mass spectrometry ion source device according to claim 10, wherein the inert shielding gas is nitrogen.

12. The operation method of a nano-liter photoionization mass spectrometry ion source device according to claim 10, wherein a gas inlet and a gas outlet are formed on opposite sides of the square chamber for entry and exhaust of the inert shielding gas, respectively.

13. The operation method of a nano-liter photoionization mass spectrometry ion source device according to claim 12, wherein a dopant inlet is formed on a side of the gas inlet on the square chamber.

14. The operation method of a nano-liter photoionization mass spectrometry ion source device according to claim 9, wherein the nano-tip is made of a borosilicate glass.

15. The operation method of a nano-liter photoionization mass spectrometry ion source device according to claim 9, wherein the metal electrode is an inert metal material.

16. The operation method of a nano-liter photoionization mass spectrometry ion source device according to claim 15, wherein the inert metal material is a platinum wire.

17. The operation method of a nano-liter photoionization mass spectrometry ion source device according to claim 9, wherein during the detection of the step S3, nitrogen and a dopant are introduced into the square chamber prior to switching on the high voltage source.

18. The operation method of a nano-liter photoionization mass spectrometry ion source device according to claim 10, wherein during the detection of the step S3, nitrogen and a dopant are introduced into the square chamber prior to switching on the high voltage source.

19. The operation method of a nano-liter photoionization mass spectrometry ion source device according to claim 11, wherein during the detection of the step S3, nitrogen and a dopant are introduced into the square chamber prior to switching on the high voltage source.

20. The operation method of a nano-liter photoionization mass spectrometry ion source device according to claim 12, wherein during the detection of the step S3, nitrogen and a dopant are introduced into the square chamber prior to switching on the high voltage source.
